(19) United States
(12) Patent Application Publication
(10) Pub. No.: US 2015/0167994 A1
(43) Pub. Date: Jun. 18, 2015

(54) HVAC CONTROL SYSTEM

(71) Applicant: Carrier Corporation, Farmington, CT (US)

(72) Inventors: Olivier Josserand, La Boisse (FR); Jean-Philippe Goux, Toussieu (FR); Eric Royet, Thil (FR)

(21) Appl. No.: 14/403,644

(22) PCT Filed: May 30, 2012
(86) PCT No.: PCT/IB2012/001210

§ 371 Date: Nov. 25, 2014

(51) Int. Cl. F24F 11/00; G05B 15/02

(52) U.S. Cl. CPC F24F 11/006; G05B 15/02

(57) ABSTRACT

A heating ventilation and air conditioning (HVAC) system includes a plurality of heating, ventilation and air conditioning (HVAC) units servicing a plurality of zones of a building. A plurality of controllers is connected to the plurality of HVAC units, each controller servicing one or more zones of the plurality of zones. The plurality of controllers include at least one first controller servicing at least one first zone that is powered off when the HVAC system is in a first operating mode and a second controller servicing a second zone of the plurality of zones that remains powered on when the HVAC system is in the first operating mode. The at least one second controller is operably connected to the at least one first controller to enable powering on of the first controller when an environmental condition in the second zone falls outside of a selected range.

### BACKGROUND OF THE INVENTION

The subject matter disclosed herein relates to heating, ventilation and air conditioning (HVAC) systems. More specifically, the subject matter disclosed herein relates to control systems for HVAC systems.

In a large space or building, an HVAC system includes several individual HVAC units that are used to control the environmental conditions of the space. Each unit is controlled by a controller containing set point information and linked to sensors such as thermostats and humidity sensors. In some spaces, each HVAC unit may service several zones, with each zone having its own controller. Such spaces, for example, commercial office buildings, are only occupied for a small part of a year as a whole, about 2300 hours (based on typical working hours multiplied by a scale factor) out of the 8760 hours in a year, which is about 26% of the year. It is typical to have different set points and ranges for the HVAC system for times when the building is occupied (“occupied mode”), and for times when the building is typically unoccupied (“unoccupied mode”). For example, when operating in occupied mode, the heating set point of the system may be 22° Celsius and the cooling set point may be 25° Celsius, within a 1° Celsius range. In unoccupied mode, the heating set point may be 14° Celsius and the cooling set point may be 32° Celsius, within a 10° Celsius range. Such variations in set points results in considerable energy savings since the HVAC system is operated more sparingly during unoccupied time.

Such operation of the HVAC units themselves has become highly optimized to the point where energy consumption by the controllers themselves is no longer negligible, and is in fact quite significant. In some cases, the energy consumption by the controllers may be about 25% of the entire HVAC system.

### BRIEF DESCRIPTION OF THE INVENTION

In one embodiment, a heating ventilation and air conditioning (HVAC) system includes a plurality of heating, ventilation and air conditioning (HVAC) units servicing a plurality of zones of a building. A plurality of controllers is connected to the plurality of HVAC units, each controller servicing one or more zones of the plurality of zones. The plurality of controllers include at least one first controller servicing at least one first zone that is powered off when the HVAC system is in a first operating mode and a second controller servicing a second zone of the plurality of zones that remains powered on when the HVAC system is in the first operating mode. The at least one second controller is operably connected to the at least one first controller to enable powering on of the first controller when an environmental condition in the second zone falls outside of a selected range.

In another embodiment, a method of operating a heating, ventilation and air conditioning (HVAC) system includes switching the HVAC system to a first operating mode and powering off a plurality of first controllers. The first controllers are operably connected to a plurality of HVAC units and service one or more first zones of a plurality of zones. One or more environmental conditions of a second zone of the plurality of zones are monitored via a second controller operably connected to the plurality of first controllers. The plurality of first controllers are powered on when the one or more environmental conditions in the second zone fall outside of a selected range.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic view of an embodiment of a heating, ventilation and air conditioning system.

The detailed description explains embodiments of the invention, together with advantages and features, by way of example with reference to the drawing.

### DETAILED DESCRIPTION OF THE INVENTION

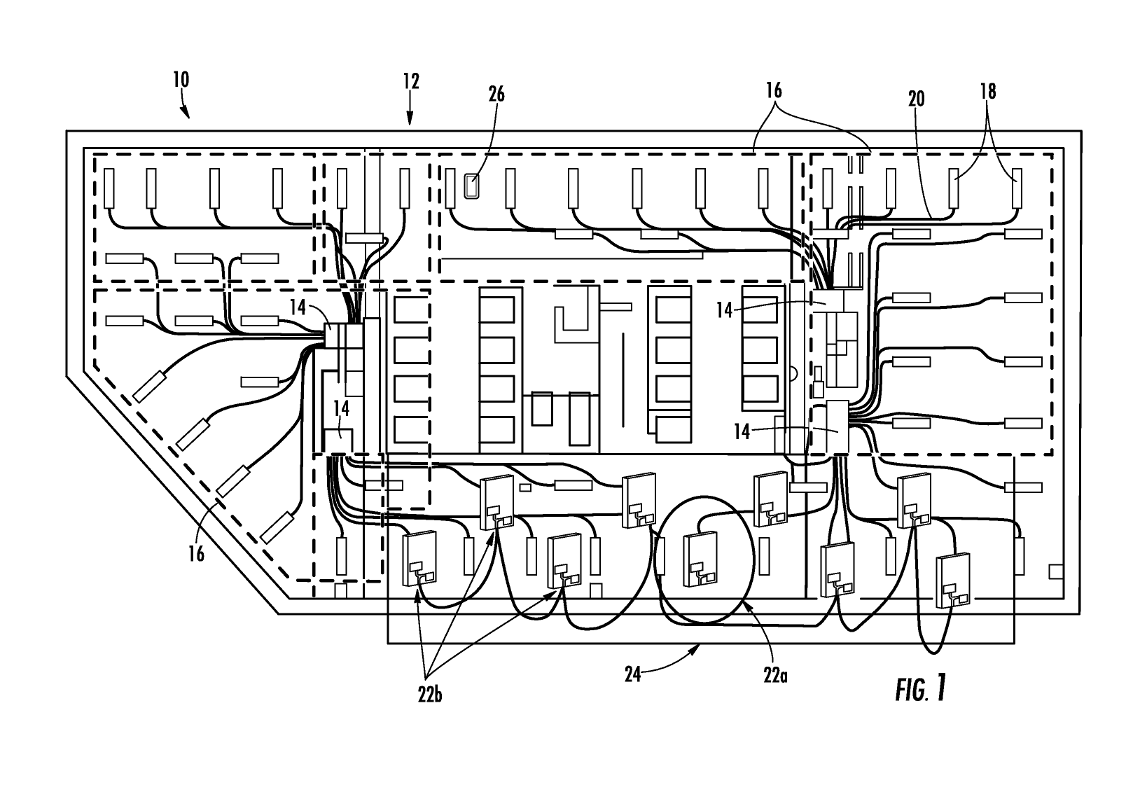

Shown in FIG. 1 is a space, for example, a floor of a building 10. The climate in the building 10 is maintained by a heating, ventilation and air conditioning (HVAC) system 12, with components thereof located throughout the building 10. The HVAC system 12 includes a number of HVAC units 14 arrayed around the building 10, to service a number of zones 16 or portions of the building 10. An individual HVAC unit 14 may service a single zone 16, or may serve multiple zones 16. Each HVAC unit 14 has a number of diffusers 18 connected to the unit 14 via ducts 20. The ducts 20 distribute airflow at a selected temperature to portions of the zones 16 serviced by the HVAC units 14, and the airflow is flowed from the ducts 20 into the zones 16 via the diffusers 18.

Each HVAC unit 14 is connected to one or more controllers 22, depending on how many zones 16 the individual HVAC unit 14 services. The controllers 22 are interconnected, and in some embodiments the controllers 22 are collocated, forming a controller colony 24 at one location in the building 10. The controllers 22 are connected to sensors 26, such as thermostats and humidity sensors, located in the zones 16 controlled by the controllers 22.

The HVAC system 12 operates in two modes, occupied mode at times when the building is likely to be occupied, and unoccupied mode at times when the building is likely to be unoccupied, such as off-work hours on weekends or evenings. During occupied mode operation of the HVAC system 12, a heating set point of the HVAC system 12 may be 22° Celsius and the cooling set point may be 25° Celsius, within a 1° Celsius range. In unoccupied mode, the heating set point may be 14° Celsius and the cooling set point may be 32° Celsius, within a 10° Celsius range.

In occupied mode, the controllers 22 are all powered and operational to control the climate in their respective zones 16. When the HVAC system 12 is in unoccupied mode, however, one controller 22 is designated as a sentinel control unit 22a, while the other controllers are designated as sleeper controllers 22b.

When the temperature of the zone 16 controlled by the sentinel controller 22a is within the selected range, the sleeper controllers 22b are powered off, thus reducing energy consumption. If the temperature of the zone 16 controlled by the sentinel controller 22a is outside of the selected range, however, this indicates that temperatures in other zones 16 controlled by the sleeper controllers 22b may also be outside of their selected range. In this case, the sentinel controller 22a resumes power flow to the sleeper controllers 22b, “waking” them. The sentinel controller 22a and the sleeper controllers 22b will then direct the HVAC units 14 servicing their respective zones 16 to cool or heat the zones 16 as needed such that the temperatures in the various zones 16 return to within the selected range. When the temperatures in each zone 16 return to within the selected range and are stabilized for a selected time, for example, 30 minutes, the power is again turned off to the sleeper controllers 22b and they return to sleep.

The sentinel controller 22a location is selected to control the sleeper controllers 22b in a desired manner, for example a zone 16 where the temperature changes the most rapidly. In some embodiments, this is the zone 16 where temperature decreases most rapidly in the winter time.

The controllers 22a and 22b are connected to a central building management system (not shown) that controls, for example, schedules for transitioning to occupied mode from unoccupied mode and vice versa. When changing from unoccupied mode to occupied mode, the building management system transmits signals to the controllers 22a and 22b to awaken them, if necessary. Alternatively, the sentinel controller 22a may act as the building management system and transmit signals to the sleeper controllers 22b to awaken them when transitioning from unoccupied mode to occupied mode.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A heating ventilation and air conditioning (HVAC) system comprising:
a plurality of heating, ventilation and air conditioning (HVAC) units servicing a plurality of zones of a building; and
a plurality of controllers connected to the plurality of HVAC units, each controller servicing one or more zones of the plurality of zones, the plurality of controllers including:
at least one first controller servicing at least one first zone that is powered off when the HVAC system is in a first operating mode; and
a second controller servicing a second zone of the plurality of zones that remains powered on when the HVAC system is in the first operating mode, and is operably connected to the at least one first controller to enable powering on of the first controller when an environmental condition in the second zone falls outside of a selected range.

2. The HVAC system of claim 1, wherein the plurality of controllers are disposed at a common location.

3. The HVAC system of claim 1, wherein at least one HVAC unit of the plurality of HVAC units services more than one zone of the plurality of zones.

4. The HVAC system of claim 3, wherein the at least one HVAC unit is connected to more than one controller of the plurality of controllers.

5. The HVAC system of claim 1, wherein the first operating mode is an unoccupied mode.

6. The HVAC system of claim 1, wherein the environmental condition is temperature.

7. The HVAC system of claim 1, further comprising at least one sensor disposed at each zone of the plurality of zones and operably connected the plurality of controllers.

8. The HVAC system of claim 7, wherein the at least one sensor is a thermostat.

9. The HVAC system of claim 1, further comprising a plurality of diffusers operably connected to the plurality of HVAC units to distribute air from the plurality of HVAC units to the plurality of zones.

10. A method of operating a heating, ventilation and air conditioning (HVAC) system comprising:
switching the HVAC system to a first operating mode;
powering off a plurality of first controllers, the first controllers operably connected to a plurality of HVAC units and servicing one or more first zones of a plurality of zones;
monitoring one or more environmental conditions of a second zone of the plurality of zones via a second controller operably connected to the plurality of first controllers; and
powering on the plurality of first controllers when the one or more environmental conditions in the second zone fall outside of a selected range.

11. The method of claim 10, further comprising powering on the plurality of first controllers via a signal from the second controller.

12. The method of claim 10, wherein the one or more environmental conditions includes temperature.

13. The method of claim 10, further comprising monitoring and/or controlling the one or more environmental conditions in the one or more first zones via the plurality of first controllers.

14. The method of claim 13, further comprising powering down the plurality of first controllers when the one or more environmental conditions in the one or more first zones are within the selected range.
